(19) United States
(12) Patent Application Publication
(10) Pub. No.: US 2026/0318327 A1
(43) Pub. Date: Oct. 15, 2026

(54) HYDRAULIC PRESSURE CIRCUIT

(71) Applicant: EAGLE INDUSTRY CO., LTD., Tokyo (JP)

(72) Inventors: Yoshiyuki SHIMADA, Tokyo (JP); Takeshi MIYATA, Tokyo (JP); Yuichi ISHII, Tokyo (JP); Kiyotaka FURUTA, Tokyo (JP)

(21) Appl. No.: 19/107,469

(22) PCT Filed: Nov. 2, 2023
(86) PCT No.: PCT/JP2023/039702

§ 371 Date: Feb. 27, 2025

(30) Foreign Application Priority Data
Nov. 24, 2022 (JP) 2022-187166

(51) Int. Cl. F15B 11/024; E02F 9/12; E02F 9/22; F15B 13/04

(52) U.S. Cl. CPC F15B 11/024; E02F 9/2203; E02F 9/2217; F15B 13/0401; E02F 9/123; E02F 9/2285; F15B 2013/041

(57) ABSTRACT

A fluid pressure circuit includes a pressure supply source; an actuator device actuated by a fluid from the pressure supply source; a direction switching valve provided in main flow passages between the pressure supply source and the actuator device; a regenerative system connected to the main flow passages via a branch flow passage; and a control valve that controls a flow rate from the main flow passages to the branch flow passage. A throttle that throttles the fluid from the main flow passages is disposed in the branch flow passage. The control valve receives a fluid pressure of a main flow passage and a fluid pressure of a branch flow passage obtained by the throttle, and is controlled by a differential pressure between the fluid pressure and the fluid pressure.

### TECHNICAL FIELD

The present invention relates to a fluid pressure circuit, for example, a fluid pressure circuit that controls a fluid actuator in response to an operation command.

### BACKGROUND ART

A fluid pressure circuit is used to control a fluid actuator in response to an operation command in an automobile, a construction machine, a cargo handling vehicle, an industrial machine, and the like. For example, a fluid pressure circuit in a hydraulic excavator rotates a hydraulic motor by supplying a pressure fluid from a hydraulic pump.

For example, a fluid pressure circuit as described in Patent Citation 1 swings an upper structure using a swing motor that is a hydraulic motor, and is mainly composed of a pump, the swing motor, a control valve, a regulating valve, and an accumulator. The swing motor is rotated by oil fed from the pump. The control valve is provided between the pump and the swing motor. The control valve can switch the direction in which the oil fed from the pump passes through the swing motor. Depending on the flow direction, the rotation direction of the swing motor is switched.

In addition, the control valve can be switched to a neutral position where the oil is not supplied to both a first port and a second port of the swing motor. For example, when the control valve is switched to the neutral position while the swing motor is driven, the pressure of the oil in a motor pipe that fluidly connects a downstream side of the swing motor and the control valve increases. Accordingly, the rotation of the swing motor can be stopped.

An accumulator pipe is branched and connected to the motor pipe. The regulating valve and the accumulator are fluidly connected to the accumulator pipe. The regulating valve is a proportional flow control valve. Accordingly, when the control valve is switched to the neutral position, the opening degree of the regulating valve is regulated, so that some of the oil in the motor pipe can be stored in the accumulator.

### CITATION LIST

### Patent Literature

Patent Citation 1: JP 2011-514954 A (Pages 5 to 8, FIG. 2)

### SUMMARY OF INVENTION

### Technical Problem

In the fluid pressure circuit as described in Patent Citation 1, the opening degree of the regulating valve is regulated according to the pressure of the accumulator.

Accordingly, the hydraulic circuit can store an appropriate amount of the oil in the accumulator. Meanwhile, when the rotation of the swing motor is stopped and the regulating valve receives a very high pressure, the opening degree of the regulating valve widens instantaneously, and the deviation from a target flow rate is increased, so that the fluid pressure for stopping the rotation of the swing motor is lost, which is a risk.

Therefore, when the opening degree of the regulating valve is detected, it is also known to detect not only the pressure on an accumulator side, but also the pressure on a swing motor side that increases when the swing motor is stopped. In such a configuration, the opening degree of the regulating valve can be regulated using the pressure on the accumulator side and the pressure on the swing motor side. Accordingly, the fluid pressure for stopping the rotation of the swing motor can be reliably ensured.

However, in order to regulate the opening degree of the regulating valve based on the pressure on the accumulator side and the pressure on the swing motor side, it is necessary to detect each pressure, calculate the opening degree of the regulating valve from these pressures, determine an electric signal to be input to the regulating valve, and output the electric signal. As a result, there is room for improvement in responsiveness.

The present invention has been made in view of such problems, and an object of the present invention is to provide a fluid pressure circuit capable of supplying a fluid to a regenerative system with good responsiveness.

### Solution to Problem

In order to solve the foregoing problems, a fluid pressure circuit according to the present invention is a fluid pressure circuit including: a pressure supply source; an actuator device actuated by a fluid from the pressure supply source; a direction switching valve provided in a main flow passage between the pressure supply source and the actuator device; a regenerative system connected to the main flow passage via a branch flow passage; and a control valve that controls a flow rate from the main flow passage to the branch flow passage, wherein a throttle that throttles the fluid from the main flow passage is disposed in the branch flow passage, and the control valve receives a main fluid pressure of the main flow passage and a branch fluid pressure of the branch flow passage obtained by the throttle, and is controlled by a differential pressure between the main fluid pressure and the branch fluid pressure. According to the aforesaid feature of the present invention, the control valve is controlled using the differential pressure between the pressure of the main flow passage and the pressure of the branch flow passage. As a result, the fluid pressure circuit can supply the fluid to the regenerative system with good responsiveness.

It may be preferable that the throttle is a variable throttle that is controlled based on information obtained from the regenerative system. According to this preferable configuration, the fluid pressure circuit can supply an appropriate amount of the fluid to the regenerative system.

It may be preferable that the information obtained from the regenerative system is an electric signal obtained from a sensor disposed on a regenerative system side. According to this preferable configuration, since the opening degree of the variable throttle is controlled in response to the electric signal from the sensor on the regenerative system side, the configuration is simple.

It may be preferable that the throttle is provided in an actuation position of a 3-port, 2-position electromagnetic valve. According to this preferable configuration, the fluid pressure circuit can supply the fluid to the regenerative system with good responsiveness during regeneration while causing the actuator device to actuate smoothly.

### BRIEF DESCRIPTION OF DRAWINGS

FIG. 1 is a view illustrating a hydraulic excavator incorporating a hydraulic circuit as a fluid pressure circuit according to an embodiment of the present invention.

FIG. 2 is a view illustrating the hydraulic circuit in the embodiment.

FIG. 3 is a graph illustrating a relationship between a lever operation amount and an electric signal output to a switching valve in the embodiment.

FIG. 4 is a graph illustrating a relationship between the lever operation amount and an opening area of the switching valve in the embodiment.

FIG. 5 is a graph illustrating a relationship between the lever operation amount and a flow rate of a fluid supplied to a hydraulic motor in the embodiment.

FIG. 6 is a graph illustrating a relationship between the lever operation amount and an opening characteristic of an electromagnetic proportional valve in the embodiment.

FIG. 7 is a graph illustrating a relationship between pressure in a relief valve and the flow rate of the fluid passing through the relief valve in the embodiment.

FIG. 8 is a schematic view illustrating a relationship between an electric signal to be input and a priority flow rate in a flow control valve in the embodiment.

FIG. 9 is an enlarged view illustrating a control valve and a throttle in the embodiment.

FIG. 10 is a view for describing movement of the control valve in the embodiment.

FIG. 11 is a view for describing movement of the control valve in the embodiment.

### DESCRIPTION OF EMBODIMENTS

A mode for implementing a fluid pressure circuit according to the present invention will be described below based on an embodiment.

### Embodiment

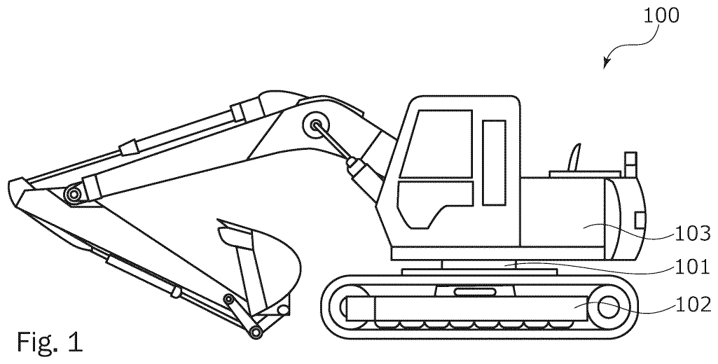

A fluid pressure circuit according to an embodiment of the present invention will be described with reference to FIGS. 1 to 11.

A hydraulic circuit serving as the fluid pressure circuit according to the embodiment is a hydraulic circuit that controls rotation of a hydraulic motor in response to an operation command in a work machine, a construction machine, a cargo handling vehicle, an automobile, and the like, and is incorporated into, for example, a swing device 101 of a hydraulic excavator 100 illustrated in FIG. 1.

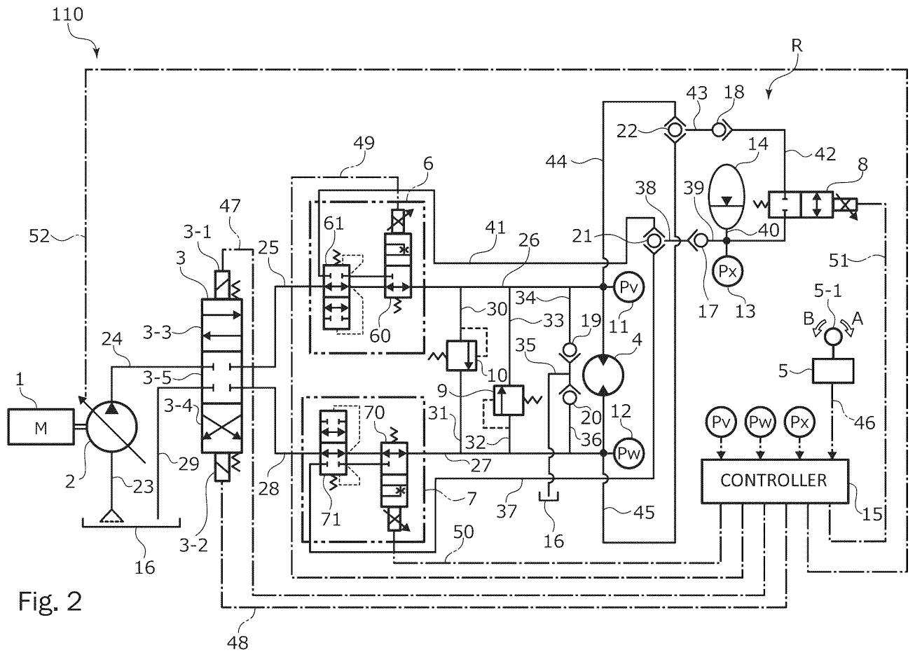

In the hydraulic excavator 100, an undercarriage 102 and a swing body 103 are connected to each other via the swing device 101. The swing body 103 is swingable in response to the rotation of a hydraulic motor 4 (refer to FIG. 2) of the swing device 101. The hydraulic motor 4 is driven by a hydraulic circuit 110 (refer to FIG. 2). Hereinafter, the hydraulic circuit 110 will be described.

As illustrated in FIG. 2, the hydraulic circuit 110 is composed of the hydraulic pump 2 serving as a fluid supply source driven by a drive mechanism 1 such as an engine or an electric motor; a direction switching valve 3; the hydraulic motor 4; a remote control 5; flow diverter valves 6 and 7; an electromagnetic proportional valve 8; relief valves 9 and 10; pressure sensors 11 to 13; an accumulator 14 serving as an auxiliary device; a controller 15; a tank 16; check valves 17 to 20; shuttle valves 21 and 22; oil passages 23 to 45; and electric signal line 46 to 52. Incidentally, the accumulator 14 is provided as an example of an auxiliary device, but is not limited thereto.

The hydraulic pump 2 is coupled to the drive mechanism 1 such as an internal combustion engine, and is rotated by power from the drive mechanism 1 to supply pressure oil to a downstream side through the oil passage 23.

The pressure oil discharged from the hydraulic pump 2 flows into the direction switching valve 3 through the oil passage 24. The direction switching valve 3 is a 6-port, 3-position, closed-center electromagnetic direction switching valve, and all ports are closed in a state where a spool is in a neutral position.

The remote control 5 is an electric joystick. When the operation lever 5-1 is operated in a right direction A or a left direction B, the remote control 5 outputs an electric signal proportional to an operation amount of the operation lever 5-1. The electric signal is input to the controller 15 through the electric signal line 46.

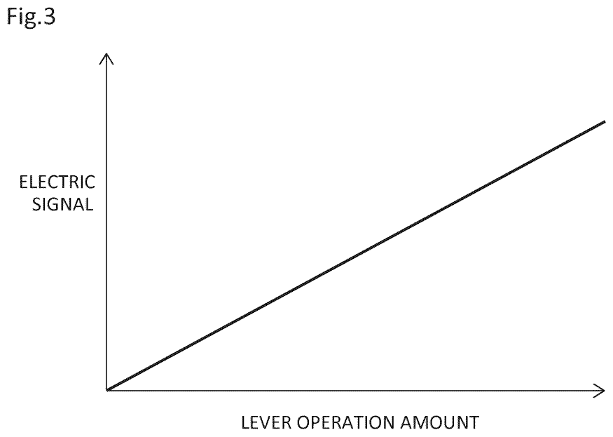

An arithmetic circuit of the controller 15 outputs an electric signal, which corresponds to the electric signal input from the remote control 5, to the electric signal line 47 or the electric signal line 48. As illustrated in FIG. 3, the electric signal output from the controller 15 to the electric signal line 47 or the electric signal line 48 is proportional to the operation amount of the operation lever 5-1.

When the operation lever 5-1 of the remote control 5 is operated in the right direction A, the electric signal output from the controller 15 is applied to a solenoid 3-1 of the direction switching valve 3 through the electric signal line 47. Accordingly, the spool of the direction switching valve 3 moves, and the direction switching valve 3 is switched to a first swing position 3-3. The pressure oil fed from the hydraulic pump 2 flows into the hydraulic motor 4 through the direction switching valve 3 and the oil passages 25 and 26, and when the pressure oil passes through the hydraulic motor 4, the pressure oil is discharged to the tank 16 through the oil passages 27 and 28, the direction switching valve 3, and the oil passage 29. At this time, the hydraulic motor 4 is rotated in a clockwise direction.

Similarly, when the operation lever 5-1 of the remote control 5 is operated in the left direction B, the electric signal output from the controller 15 is applied to a solenoid 3-2 of the direction switching valve 3 through the electric signal line 48. Accordingly, the spool of the direction switching valve 3 moves, and the direction switching valve 3 is switched to a second swing position 3-4. The pressure oil fed from the hydraulic pump 2 flows into the hydraulic motor 4 through the direction switching valve 3 and the oil passages 28 and 27, and when the pressure oil passes through the hydraulic motor 4, the pressure oil is discharged to the tank 16 through the oil passages 26 and 25, the direction switching valve 3, and the oil passage 29. At this time, the hydraulic motor 4 is rotated in a counterclockwise direction.

In such a manner, the oil passages 23 to 29 through which the pressure oil passes when the hydraulic motor 4 is rotated are a main flow passage in the present embodiment.

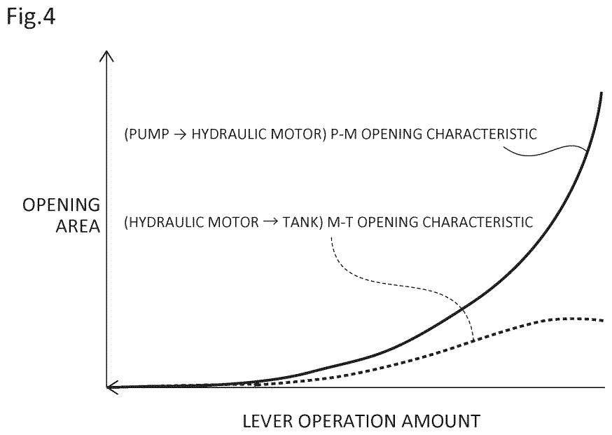

As illustrated in FIG. 4, the direction switching valve 3 is configured such that the spool strokes substantially in proportion to the electric signal input from the controller 15 through the electric signal line 47 or the electric signal line 48. Accordingly, the direction switching valve 3 increases a P-M (pump-hydraulic motor) opening area and an M-T (hydraulic motor>tank) opening area according to the spool stroke.

In addition, the arithmetic circuit of the controller 15 also outputs an electric signal, which corresponds to the electric signal input from the remote control 5, to the electric signal line 52.

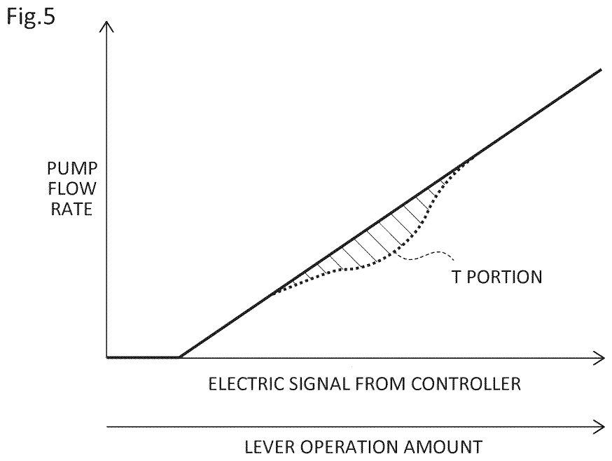

As illustrated in FIG. 5, the hydraulic pump 2 is configured such that the feed amount of the pressure oil variably changes substantially in proportion to the electric signal input from the controller 15 through the electric signal line 52.

Accordingly, as the P-M (pump >hydraulic motor) opening area increases and the amount of the pressure oil fed from the hydraulic pump 2 increases due to an increase in the operation amount of the remote control 5, the amount of the pressure oil supplied to the hydraulic motor 4 increases, and the rotation speed of the hydraulic motor 4 increases. Namely, the rotation speed of the hydraulic motor 4 can be controlled according to the inclination of the operation lever 5-1.

Returning to FIG. 2, the oil passages 30, 33, and 34 are branched and connected to the oil passage 26. The oil passages 31, 32, and 36 are branched and connected to the oil passage 27.

The relief valve 10 is provided between the oil passage 30 and the oil passage 31. The relief valve 10 opens when the pressure in the oil passage 30 reaches a predetermined pressure or higher, so that communication between the oil passages 30 and 31 is allowed.

The relief valve 9 is provided between the oil passage 32 and the oil passage 33. The relief valve 9 opens when the pressure in the oil passage 32 reaches a predetermined pressure or higher, so that communication between the oil passages 32 and 33 is allowed.

The oil passage 34 is connected to the oil passage 35 via the check valve 19. The check valve 19 is configured to allow the oil to pass from the oil passage 35 to the oil passage 34. The oil passage 36 is connected to the oil passage 35 via the check valve 20. The check valve 20 is configured to allow the oil to pass from the oil passage 35 to the oil passage 36. The oil passage 35 communicates with the tank 16.

In addition, the pressure sensor 11 is connected to the oil passage 26. The pressure sensor 12 is connected to the oil passage 27. The pressure sensors 11 and 12 can input a detected pressure value Pv or pressure value Pw to the controller 15 as an electric signal.

In addition, a regenerative system R is connected to the hydraulic circuit 110 via a branch flow passage branching from the oil passages 25, 26, 27, and 28 that are a part of the main flow passage. The branch flow passage is composed of the flow diverter valves 6 and 7, the shuttle valves 21 and 22, and the oil passages 37, 41, 44, and 45. The regenerative system R is mainly composed of the electromagnetic proportional valve 8, the pressure sensor 13, the accumulator 14, the check valves 17 and 18, and the oil passages 38 to 40, 42, and 43.

The flow diverter valve 6 is provided between the oil passages 25 and 26. The flow diverter valve 6 is also connected to the oil passage 41. The flow diverter valve 6 can switch between allowing the pressure oil to pass only between the oil passages 25 and 26 and allowing the pressure oil to flow into the oil passage 41 in addition to allowing the pressure oil to pass between the oil passages 25 and 26. The flow diverter valve 6 will be described later.

The flow diverter valve 7 is provided between the oil passages 27 and 28. The flow diverter valve 7 is also connected to the oil passage 37. The flow diverter valve 7 can switch between allowing the pressure oil to pass only between the oil passages 27 and 28 and allowing the pressure oil to flow into the oil passage 37 in addition to allowing the pressure oil to pass between the oil passages 27 and 28. The flow diverter valve 7 will be described later.

The oil passages 37 and 41 are connected in parallel to the shuttle valve 21. In addition, the oil passage 38 is connected to the shuttle valve 21. The shuttle valve 21 is configured to allow communication between one of the oil passages 37 and 41, which has a higher internal pressure, and the oil passage 38.

The oil passage 38 is connected to the oil passage 39 via the check valve 17. The check valve 17 is configured to allow the pressure oil to pass from the oil passage 38 to the oil passage 39. In addition, the accumulator 14, the pressure sensor 13, and the electromagnetic proportional valve 8 are connected to the oil passage 39. The pressure sensor 13 can input the detected pressure value Px to the controller 15 as an electric signal.

In addition, the shuttle valve 22 is connected to the electromagnetic proportional valve 8 via the oil passage 42, the check valve 18, and the oil passage 43. The check valve 18 is configured to allow the pressure oil to pass from the oil passage 42 to the oil passage 43. In addition, the oil passages 44 and 45 are connected in parallel to the shuttle valve 22. The shuttle valve 22 is configured to allow communication between one of the oil passages 44 and 45, which has a higher internal pressure, and the oil passage 43.

The electromagnetic proportional valve 8 is a 2-port, 2-position electromagnetic proportional flow control valve. The arithmetic circuit of the controller 15 also outputs an electric signal, which corresponds to the electric signal input from the remote control 5, to the electric signal line 51.

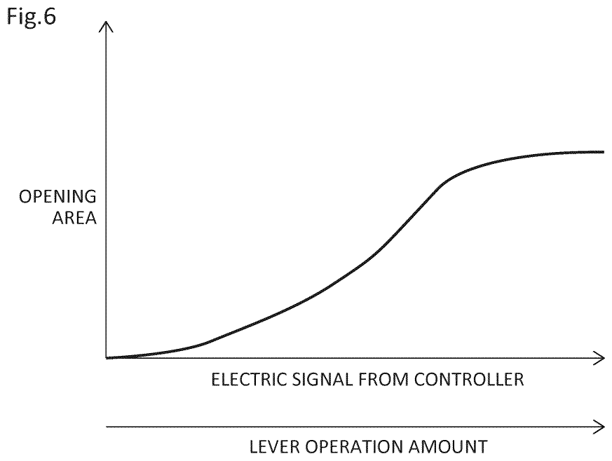

As illustrated in FIG. 6, the electromagnetic proportional valve 8 is configured such that the opening area variably changes substantially in proportion to the electric signal input from the controller 15 through the electric signal line 51.

When the pressure value Px input from the pressure sensor 13 reaches a predetermined value or more in a state where the remote control 5 is operated, the controller 15 outputs an electric signal corresponding to the operation amount of the remote control 5 to the electromagnetic proportional valve 8. Accordingly, the opening degree of the electromagnetic proportional valve 8 can be regulated such that the opening area corresponds to the electric signal, and the pressure oil can be supplied from the accumulator 14 to the oil passage 44 or the oil passage 45. Accordingly, the pressure oil in a T portion illustrated by hatching in FIG. 5 can be supplied from the accumulator 14 to the hydraulic motor 4.

In addition, when the controller 15 outputs an electric signal to the electromagnetic proportional valve 8, the controller 15 also outputs an electric signal to the hydraulic pump 2 to reduce the amount of the pressure oil fed from the hydraulic pump 2. Accordingly, the energy required to drive the hydraulic pump 2 can be reduced.

Next, fluid storage control to the accumulator 14 in the regenerative system R will be described. The storage of the fluid in the accumulator 14 is performed using a fluid pressure Pl that increases in the oil passages 25 and 26 or the oil passages 27 and 28 when the operation lever 5-1 in operation is returned to a neutral position at once, namely, a so-called sudden stop operation is performed. First, this increase in the fluid pressure Pl will be described.

For example, when the operation lever 5-1 is returned to the neutral position at once from a state where the operation lever 5-1 is operated to a maximum amount in the left direction B, the direction switching valve 3 is switched from the second swing position 3-4 to a neutral position 3-5. Accordingly, the supply of the pressure oil from the hydraulic pump 2 to the oil passage 28 is stopped, and the discharge of the pressure oil from the oil passage 25 to the tank 16 is also stopped.

Meanwhile, the swing body 103 that is swung by the rotational force of the hydraulic motor 4 until just before tries to continue rotating due to an inertial force. The inertial force also acts on the hydraulic motor 4, and rotates the hydraulic motor 4. When the hydraulic motor 4 rotates, a pumping action occurs, so that the pressure oil is pumped from the oil passage 27 to the oil passage 26, and the fluid pressure Pl in the oil passage 26 and 25 increases. The fluid pressure Pl that increases in the oil passages 26 and 25 acts as resistance against the rotation of the hydraulic motor 4, in other words, the pumping of the pressure oil to the oil passage 26. Accordingly, the rotation speed of the hydraulic motor 4 is reduced and finally comes to a stop.

Meanwhile, in the oil passages 28 and 27, the pressure oil is suctioned in response to the rotation of the hydraulic motor 4, so that the internal fluid pressure decreases. Accordingly, when the internal pressure reaches the pressure of the oil in the tank 16 or lower, the oil in the tank 16 is suctioned up into the oil passages 28 and 27 through the oil passages 35 and 36. Accordingly, the occurrence of cavitation in the oil passages 28 and 27 is suppressed.

Incidentally, since the operation when the operation lever 5-1 is operated in the right direction A and returned to the neutral position is substantially the same as that when the operation lever 5-1 is operated in the left direction B and returned to the neutral position, except that the flow direction changes as described above, the description thereof will be omitted.

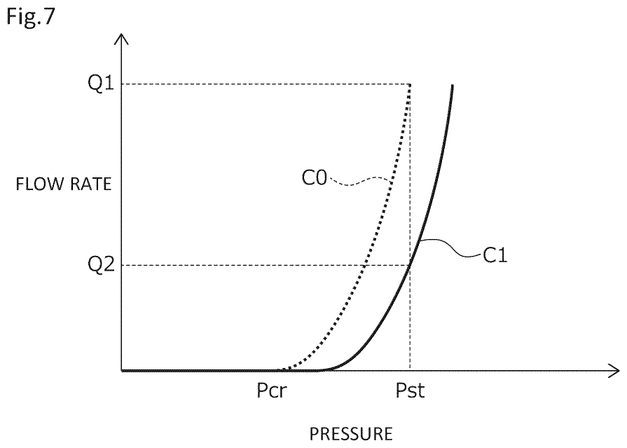

The relief valves 9 and 10 have a pressure override characteristic illustrated by a curve C1 in FIG. 7. In order to describe the pressure override characteristic, first, a pressure override characteristic illustrated by a curve C0 in FIG. 7 will be described. The curve C0 indicates a flow rate Q passing through a relief valve substantially in proportion to an increase in the fluid pressure P1, and the relief valve starts to open at a cracking pressure Pcr, and allows a flow rate Q1 to pass at a set pressure Pst.

The flow rate Q1 is the total flow rate of the pressure oil discharged from the hydraulic motor 4 by the pumping action due to the inertial force acting on the swing body 103 when the operation lever 5-1 is returned to the neutral position at once from a state where the operation lever 5-1 is operated to the maximum amount. In addition, the set pressure Pst is a pressure required to stop the swing body 103 within a predetermined angle around the shaft of the hydraulic motor 4 when the swing body 103 is brought to a stop. Accordingly, after the operation lever 5-1 is operated to the neutral position, a risk of the swing body 103 swinging excessively or a risk of damage to the hydraulic circuit due to an excessive increase in pressure, namely, an accident caused by a so-called excessive swing flow is prevented.

For these reasons, a hydraulic circuit to which the relief valve having the pressure override characteristic illustrated by the curve C0 is applied needs to discharge the amount of the pressure oil, which is more than the amount of the pressure oil required to maintain the set pressure Pst, to the outside of an oil passage provided with the relief valve in which the set pressure Pst is generated.

As illustrated by the curve C1, the pressure override characteristic of the relief valves 9 and 10 of the present embodiment is set such that a flow rate Q2 less than the flow rate Q1 passes at the set pressure Pst. Therefore, in the hydraulic circuit 110 of the present embodiment, compared with the hydraulic circuit to which the relief valve having the pressure override characteristic illustrated by the curve C0 is applied, when the fluid pressure P1 downstream of the hydraulic motor 4 in the flow direction of the pressure oil reaches the set pressure Pst, an excess oil amount ΔQ (ΔQ=Q1−Q2) can be generated on the same downstream side.

The hydraulic circuit 110 can store the excess oil amount ΔQ in the accumulator 14 by controlling one of the flow diverter valves 6 and 7 located downstream of the hydraulic motor 4 in the flow direction of the pressure oil.

Accordingly, the hydraulic circuit 110 prevents accidents caused by an excessive swing flow.

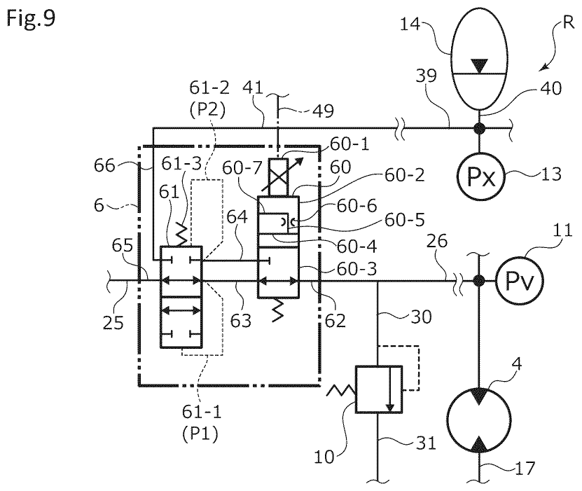

As illustrated in FIG. 9, the flow diverter valve 6 includes a flow control valve 60; a pressure compensation valve 61 serving as a control valve; and oil passages 62 to 66.

The flow control valve 60 is a 3-port, 2-position electromagnetic proportional flow control valve. A solenoid 60-1 of the flow control valve 60 is connected to the controller 15 through the electric signal line 49.

The flow control valve 60 is connected to the oil passage 26 via the oil passage 62. In addition, the oil passages 63 and 64 are connected in parallel to the flow control valve 60. In addition, the oil passages 63 and 64 are also connected in parallel to the pressure compensation valve 61. In addition, the oil passage 63 can communicate with the oil passage 65 via the pressure compensation valve 61. In addition, the oil passage 65 is connected in communication with the oil passage 25. The oil passage 64 is connected to the oil passage 66 via the pressure compensation valve 61. In addition, the oil passage 66 communicates with the oil passage 41.

The flow control valve 60 is in a neutral position 60-3 in a state where no electric signal is input from the controller 15 to the solenoid 60-1. In the neutral position 60-3, the oil passage 62 and the oil passage 63 are in communication with each other, and the oil passage 62 and the oil passage 64 are not in communication with each other. Therefore, in the neutral position 60-3, the pressure oil is allowed to flow between the oil passages 25 and 26.

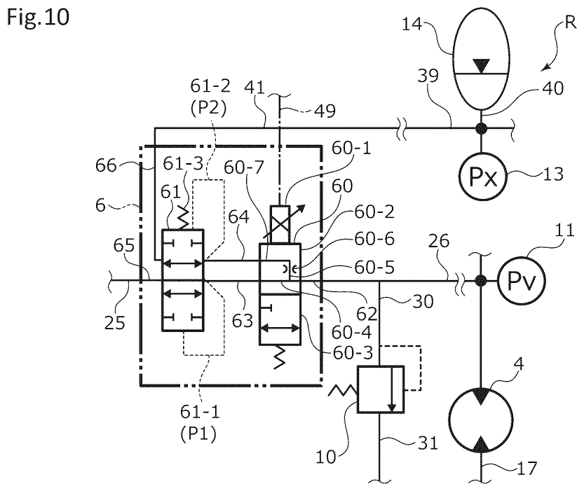

As illustrated in FIG. 10, the flow control valve 60 is switched to an actuation position 60-2 when an electric signal is input from the controller 15 to the solenoid 60-1. In the actuation position 60-2, an oil passage 60-4, an oil passage 60-5, a variable throttle 60-6, and an oil passage 60-7 are provided.

In the actuation position 60-2, the oil passage 60-4 is connected to the oil passage 62 and the oil passage 63. In addition, the oil passage 60-5 is branched and connected to the oil passage 60-4. The oil passage 60-7 is connected to the oil passage 60-5 via the variable throttle 60-6. In the actuation position 60-2, the oil passage 60-7 is connected to the oil passage 64. Accordingly, in the actuation position 60-2, the oil passage 62 and the oil passage 63 are in communication with each other, and the oil passage 64 is also in communication therewith.

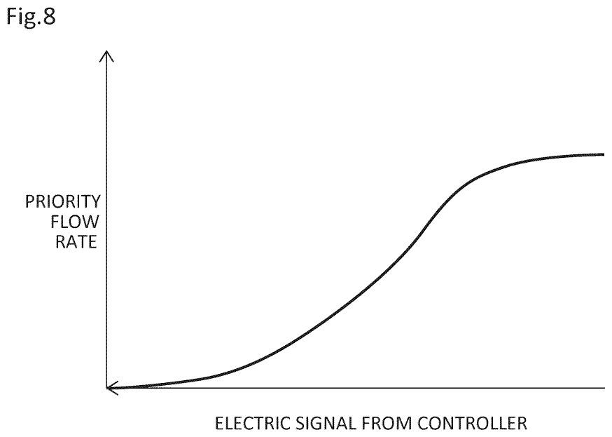

As illustrated in FIG. 8, the flow control valve 60 variably changes a priority flow rate substantially in proportion to the electric signal from the controller 15. The priority flow rate is the amount of the pressure oil supplied to the oil passage 64 through the variable throttle 60-6. Namely, in the flow control valve 60, the opening area of the variable throttle 60-6 variably changes substantially in proportion to the electric signal from the controller 15.

Therefore, in the actuation position 60-2, not only is the pressure oil allowed to flow between the oil passages 25 and 26, but also the pressure oil is allowed to branch from the oil passages 25 and 26 constituting the main flow passage and to flow into the oil passage 41.

The pressure compensation valve 61 includes an oil passage 61-1, an oil passage 61-2, and a spring 61-3.

The oil passage 61-1 connects a back pressure chamber (not illustrated) defined on a paper lower side of a spool of the pressure compensation valve 61 and the oil passage 63 in communication with each other. The oil passage 61-2 connects a back pressure chamber (not illustrated) defined on a paper upper side of the spool and the oil passage 64 in communication with each other. Accordingly, the fluid pressure Pl acts on a pressure-receiving surface (not illustrated) on the paper lower side of the spool, as a so-called pilot pressure of the pressure oil supplied from the oil passage 63 through the oil passage 61-1. A fluid pressure P2 acts on a pressure-receiving surface (not illustrated) on the paper upper side of the spool, as a so-called pilot pressure of the pressure oil supplied from the oil passage 64 through the oil passage 61-2 and passing through the variable throttle 60-6. Incidentally, a pressure-receiving area S1 on the paper lower side of the spool and a pressure-receiving area S2 on the paper upper side are substantially the same (S1=S2).

In addition, the spring 61-3 is disposed on the paper upper side of the spool (not illustrated), and biases the spool toward the paper lower side.

Accordingly, the spool of the pressure compensation valve 61 moves according to a force F1 (F1=P1×S1) generated when the fluid pressure Pl acts on the pressure-receiving area S1 and a force Fp (Fp=F2+Fsp) obtained by adding a biasing force Fsp of the spring 61-3 to a force F2 (F2=P2×S2) generated when the fluid pressure P2 acts on the pressure-receiving area S2, and is stationary in a balanced position where the force F1 and the force Fp are balanced (F1=Fp). To summarize the force relationship in this case, a difference between the force F1 and the force F2 is constant (P1×S1=P2×S2+Fsp=constant and P1−P2=Fsp/S1=constant).

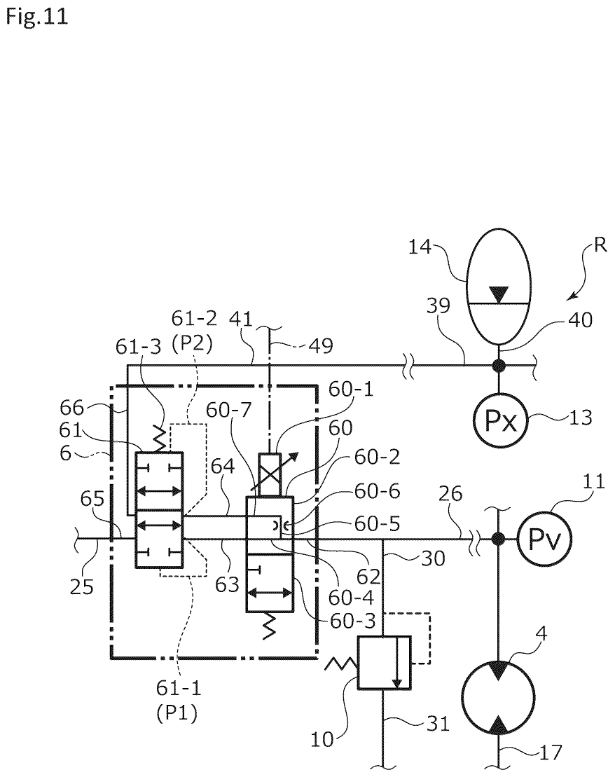

In response to the movement of the spool, the pressure compensation valve 61 displaces the opening degree between the oil passages 63 and 65 and the opening degree between the oil passages 64 and 66. In more detail, referring to FIG. 10, the further the spool moves to the paper lower side, the more the opening degree between the oil passages 63 and 65 widens and the more the opening degree between the oil passages 64 and 66 narrows. In addition, referring to FIG. 11, the further the spool moves to the paper upper side, the more the opening degree between the oil passages 63 and 65 narrows and the more the opening degree between the oil passages 64 and 66 widens. Incidentally, FIGS. 10 and 11 schematically illustrate the operation of the pressure compensation valve 61.

Next, the flow diverter valve 6 when pressure storage control to the accumulator 14 is performed will be described. When it is detected that the operation lever 5-1 operated to the maximum amount in the left direction B is returned to the neutral position at once, the controller 15 switches the direction switching valve 3 to the neutral position 3-5, sets the electromagnetic proportional valve 8 to a closed state, and determines an opening degree Ax of the variable throttle 60-6 of the flow control valve 60 with reference to the pressure value Px input from the pressure sensor 13.

For details on the determination of the opening degree Ax of the variable throttle 60-6, in the present embodiment, the excess oil amount ΔQ and the set pressure Pst are set in advance by the override characteristic of each of the relief valves 9 and 10. As a result, in the arithmetic circuit of the controller 15, an electric signal that allows the excess oil amount ΔQ to flow to an accumulator 14 side while keeping the pressure oil for ensuring the set pressure Pst is set in advance for each pressure value Px of the accumulator 14. Therefore, the controller 15 of the present embodiment can output an electric signal for controlling the opening degree to an appropriate opening degree Ax using only the pressure value Px of the accumulator 14.

The controller 15 reduces the output electric signal as the pressure value Px of the accumulator 14 decreases, and increases the output electric signal as the pressure value Px of the accumulator 14 increases. In other words, in the variable throttle 60-6, the smaller the pressure value Px of the accumulator 14 is, the narrower the opening degree Ax becomes, and the larger the pressure value Px of the accumulator 14 is, the wider the opening degree Ax becomes.

When the opening degree Ax of the variable throttle 60-6 is a narrow opening degree Ax1, a differential pressure AP between the fluid pressure P1 and the fluid pressure P2 becomes a large differential pressure ΔP10 (ΔP10=P1−P2). Namely, the fluid pressure P2 becomes low (P2<<P1).

In addition, as described above, the differential pressure ΔP10 in a state where a cylinder of the pressure compensation valve 61 is stationary in the balanced position is kept constant (ΔP10=P1−P2 =Fsp/S1=constant).

Accordingly, even when the differential pressure between the set pressure Pst and the pressure value Px on the accumulator 14 side is large, the excess oil amount ΔQ can be stored on the accumulator 14 side (ΔQ=K×Ax1×√ΔP10 (K is a constant) ). In addition, the larger the differential pressure AP between the fluid pressure P1 and the fluid pressure P2 is, the wider the opening degree between the oil passages 64 and 66 becomes.

In addition, when the opening degree Ax of the variable throttle 60-6 is a wide opening degree Ax2, the differential pressure AP between the fluid pressure P1 and the fluid pressure P2 becomes a small differential pressure ΔP20 (ΔP20=P1−P2). Namely, the fluid pressure P2 becomes high (P2<P1).

In addition, as described above, the differential pressure ΔP20 in a state where the cylinder of the pressure compensation valve 61 is stationary in the balanced position is kept constant (ΔP20=P1−P2=Fsp/S1=constant).

Accordingly, even when the differential pressure between the set pressure Pst and the pressure value Px on the accumulator 14 side is small, the excess oil amount ΔQ can be stored on the accumulator 14 side (ΔQ=K×Ax2×√ΔP20 (K is a constant) ). In addition, the smaller the differential pressure AP between the fluid pressure P1 and the fluid pressure P2 is, the narrower the opening degree between the oil passages 64 and 66 becomes.

For more details on movement of the pressure compensation valve 61, for example, as illustrated in FIG. 10, when the flow rate passing through the variable throttle 60-6 increases due to a high pressure acting on the variable throttle 60-6 and the opening degree Ax of the variable throttle 60-6 widening instantaneously in a state where the spool is stationary in the balanced position, the fluid pressure P2 in the oil passage 64 increases.

Accordingly, the spool moves to the paper lower side to the extent that the fluid pressure P2 increases, so that the opening degree between the oil passages 63 and 65 is widened and the opening degree between the oil passages 64 and 66 are narrowed. Therefore, the fluid pressure P2 increases instantaneously, the differential pressure AP between the fluid pressure P1 and the fluid pressure P2 decreases, so that the inflow of the pressure oil from the side of the oil passages 25 and 26 to the oil passage 64 can be reduced.

Thereafter, the fluid pressure P2 decreases or the fluid pressure P1 increases, so that the differential pressure AP corresponding to the opening degree Ax of the variable throttle 60-6 can be regulated to a constant differential pressure ΔP10 or differential pressure ΔP20 regardless of whether the differential pressure AP is the differential pressure ΔP10 or the differential pressure ΔP20.

As a result, the hydraulic circuit 110 can prevent the pressure oil from passing between the oil passages 64 and 66 in an amount more than or equal to the excess oil amount ΔQ, and maintain the amount of oil in the oil passages 25 and 26 required to obtain the set pressure Pst.

In addition, for example, as illustrated in FIG. 11, when the flow rate passing through the variable throttle 60-6 decreases in a state where the spool is stationary in the balanced position, the fluid pressure P2 in the oil passage 64 decreases.

Accordingly, the spool moves to the paper upper side to the extent that the fluid pressure P2 decreases, so that the opening degree between the oil passages 63 and 65 is narrowed and the opening degree between the oil passages 64 and 66 are widened. Therefore, since the fluid pressure P2 decreases instantaneously, and the differential pressure AP between the fluid pressure P1 and the fluid pressure P2 increases, the inflow of the pressure oil from the side of the oil passages 25 and 26 to the oil passage 64 can be increased.

Thereafter, the fluid pressure P1 decreases or the fluid pressure P2 increases, so that the differential pressure AP corresponding to the opening degree Ax of the variable throttle 60-6 can be regulated to a constant differential pressure ΔP10 or differential pressure ΔP20 regardless of whether the differential pressure AP is the differential pressure ΔP10 or the differential pressure ΔP20.

As a result, the hydraulic circuit 110 can suppress the discharge of the pressure oil from the relief valve 10 to the oil passage 27 side more than necessary, and the excess oil amount ΔQ is allowed to pass between the oil passages 64 and 66.

The flow diverter valve 7 includes a flow control valve 70 and a pressure compensation valve 71 serving as a control valve, and the flow control valve 70 is connected to the controller 15 through the electric signal line 50. Since the other configurations have the same as the configurations of the flow diverter valve 6, duplicate descriptions will be omitted.

As described above, in the hydraulic circuit 110 of the present embodiment, the pressure compensation valve 61 is controlled using the differential pressure AP between the fluid pressure P1 of the oil passages 25 and 26 and the fluid pressure P2 of the oil passage 64. As a result, the hydraulic circuit 110 can supply the pressure oil to the regenerative system R with good responsiveness.

In addition, the hydraulic circuit 110 uses the variable throttle 60-6 to control the amount of oil from the oil passages 25 and 26 to the oil passage 64. Therefore, the hydraulic circuit 110 can supply an appropriate amount of the pressure oil to the regenerative system R while maintaining the amount of oil in the oil passages 25 and 26 required to obtain the set pressure Pst.

In addition, the hydraulic circuit 110 has a simple configuration since an electric signal corresponding to the pressure value Px on the accumulator 14 side is input to the controller 15 from the pressure sensor 13 and the opening degree Ax of the variable throttle 60-6 is controlled accordingly.

In addition, the flow control valve 60 is a 3-port, 2-position electromagnetic valve. Therefore, the hydraulic circuit 110 can prevent the pressure oil from flowing into the regenerative system R by disposing the flow control valve 60 in the neutral position 60-3 when the hydraulic motor 4 is rotated. As a result, the hydraulic circuit 110 can actuate the hydraulic motor 4 smoothly. In addition, the flow control valve 60 is switched to the actuation position 60-2 by the input of an electric signal during regeneration. As a result, the hydraulic circuit 110 can supply the fluid to the regenerative system R with good responsiveness.

The embodiment of the present invention has been described above with reference to the drawings; however, specific configurations are not limited to the embodiment, and modifications or additions that are made without departing from the scope of the present invention are also included in the present invention.

For example, in the above-described embodiment, the configuration in which the fluid pressure circuit is a hydraulic circuit in which oil is pumped has been described; however, the present invention is not limited thereto. A fluid other than oil may be used, and the fluid to be applied may be changed as appropriate.

In addition, in the above-described embodiment, the actuator has been described as being a hydraulic motor, but is not limited thereto, and the actuator may be a hydraulic cylinder and may be changed as appropriate.

In addition, in the above-described embodiment, the configuration in which the accumulator is applied to the regenerative system has been described; however, the present invention is not limited thereto. A generator may be applied, and the configuration may be changed as appropriate as long as energy can be regenerated by the flow of a fluid.

In addition, in the above-described embodiment, the configuration in which the control valve is a pressure compensation valve has been described; however, the present invention is not limited thereto, and the configuration may be changed as appropriate as long as the valve is operated by a pilot differential pressure. As a result, the configuration may be such that the control valve can regulate the opening degree on a branch flow passage side whereas the control valve is not involved in regulating the opening degree on a main flow passage side, and in such a configuration, the opening degree on the main flow passage side may be kept at a constant opening degree that allows the fluid to flow.

In addition, in the above-described embodiment, the configuration in which the throttle is a variable throttle has been described; however, the present invention is not limited thereto, and the throttle may be a fixed throttle.

In addition, in the above-described embodiment, the configuration in which the remote control is an electric joystick has been described; however, the present invention is not limited thereto, and the remote control may be, for example, a remote control valve that variably controls the pilot pressure acting on the direction switching valve. In such a manner, for control by the controller, fluid pressure may be used as appropriate instead of an electric signal.

In addition, in the above-described embodiment, the configuration in which the variable throttle is a part of a 3-port, 2-position electromagnetic valve has been described; however, the present invention is not limited thereto, and the opening and closing valve and the variable throttle may be disposed in series or may be separate bodies. Further, when the throttle is a variable throttle, the opening and closing valve may be omitted.

### REFERENCE SIGNS LIST

1 Drive mechanism
2 Hydraulic pump (pressure supply source)
3 Direction switching valve
4 Hydraulic motor (actuator)
6, 7 Flow diverter valve
13 Pressure sensor (sensor on a regenerative system side)
14 Accumulator
23 to 29 Oil passage (main flow passage)
37, 41, 44, 45 Oil passage (branch flow passage)
60 Flow control valve (3-port, 2-position electromagnetic valve)
60-2 Actuation position
60-6 Variable throttle
61 Pressure compensation valve (control valve)
70 Flow control valve (3-port, 2-position electromagnetic valve)
71 Pressure compensation valve (control valve)
110 Hydraulic circuit (fluid pressure circuit)

1. A fluid pressure circuit, comprising:
a pressure supply source;
an actuator device actuated by a fluid from the pressure supply source;
a direction switching valve provided in a main flow passage between the pressure supply source and the actuator device;
a regenerative system configured to connect to the main flow passage via a branch flow passage; and
a control valve that is configured to control a flow rate from the main flow passage to the branch flow passage,
wherein a throttle that is configured to throttle the fluid from the main flow passage is disposed in the branch flow passage, and
the control valve receives a main fluid pressure of the main flow passage and a branch fluid pressure of the branch flow passage obtained by the throttle, and is controlled by a differential pressure between the main fluid pressure and the branch fluid pressure.

2. The fluid pressure circuit according to claim 1,
wherein the throttle is a variable throttle that is configured to control based on information obtained from the regenerative system.

3. The fluid pressure circuit according to claim 2,
wherein the information obtained from the regenerative system is an electric signal obtained from a sensor disposed on a regenerative system side.

4. The fluid pressure circuit according to claim 1,
wherein the throttle is provided in an actuation position of a 3-port, 2-position electromagnetic valve.

5. The fluid pressure circuit according to claim 2,
wherein the throttle is provided in an actuation position of a 3-port, 2-position electromagnetic valve.

6. The fluid pressure circuit according to claim 3,
wherein the throttle is provided in an actuation position of a 3-port, 2-position electromagnetic valve.
